(19) United States
(12) Patent Application Publication
(10) Pub. No.: US 2026/0157388 A1
(43) Pub. Date: Jun. 11, 2026

(54) A CHOCOLATE PRODUCT COMPRISING A MILK ANALOGUE PRODUCT

(71) Applicant: SOCIETE DES PRODUITS NESTLE S.A., Vevey (CH)

(72) Inventors: TIMOTHY JAMES WOOSTER, Orbe (CH); ISABEL CELIGUETA TORRES, York Yorkshire (GB); JANA CHRISTINA KAMMERHOFER, Bern (CH)

(21) Appl. No.: 18/710,329

(22) PCT Filed: Nov. 15, 2022
(86) PCT No.: PCT/EP2022/081945

§ 371 Date: May 15, 2024

(30) Foreign Application Priority Data
Nov. 15, 2021 (EP) 21208241.6
Dec. 16, 2021 (EP) 21215318.3

(51) Int. Cl. A23G 1/44; A23C 11/10; A23G 1/36; A23G 1/40; A23G 1/48

(52) U.S. Cl. CPC A23G 1/44; A23C 11/103; A23G 1/36; A23G 1/40; A23G 1/48

(57) ABSTRACT

The invention relates to a reduced dairy chocolate product, preferably a vegan chocolate product composition comprising a dried emulsion of a plant protein.

### BACKGROUND OF THE INVENTION

Some consumers do not want to consume milk because of its animal origin, or because of lactose intolerance or dairy allergies. They may also see potential environmental sustainability issues.

Alternatives to milk do exist on the market. However, they often have several disadvantages in terms of composition and protein quality. They generally use protein extracts or isolates as source of protein, have a long list of ingredients, are not clean label (e.g. comprise gellan gum, hydrocolloids, and other additives), and the taste can be unpleasant, bitter and/or astringent.

The traditional means of producing a milk substitute uses acid or basic treatment. Filtration or centrifugation may be used to remove large particles, which creates grittiness and bitterness. As a result, the efficiency of the process is low and good nutrients like dietary fibers are removed. In addition, taste is often an issue and many ingredients are added to mask off-taste. Furthermore, many constituents like flavors and protein concentrates are often used in alternative plant milks and those have artificial and non-natural connotations for the consumer.

Most prior art vegan compositions use filtering to reduce particle size which has the disadvantage of removing dietary fibre and other beneficial components from the composition.

The dairy alternative market is growing by 11% each year and finding an alternative with good nutrition and taste will be a major advantage in this competitive field.

There have been a number of patent publications seeking to provide solutions to the above-needs, as well as a number of documents relating to using plant-based ingredients to provide alternative ingredients for chocolate compositions.

WO 2020223623 uses roasted grain flour component. However, such solutions typically lead to undesirable organoleptic properties, i.e. “claggy” or pasty mouthfeel.

WO2019166700 relates to vegan chocolate based on oat and cocoa solids. Again, the inclusion of heavily ground oat-components leads to undesirable organoleptic properties.

WO2018167788 relates to vegan chocolate, primarily coconut flour but mentions numerous other plant-based components in speculative lists of possible ingredients. Such an approach is not suitable for overcoming the above-mentioned issues. Particular processing conditions are needed for each of the ingredients in an attempt to provide the desirable properties.

U.S. Pat. No. 4,119,740 relates to using peanut grit, almond shells or soybean flakes as a cocoa butter extender.

U.S. Pat. No. 4,296,141 discloses using soy protein isolate, carob and corn flour as a cocoa butter replacement

US20120294986 discloses the use of pea proteins to replace milk proteins, with the optional addition of vegetable fibres to the final product.

U.S. Pat. No. 9,655,374 highlights the issues with providing plant-based products without the need of numerous ingredients. This document discloses a confection comprising cocoa butter, an unsweetened cocoa powder, a glycerin, a coconut cream, an almond milk, a pectin, a salt, a monk fruit blend, and a coconut flour.

KR101303459 discloses the use of fermented rice, rye flour, whole wheat flour, oats, or glutinous rice in chocolate. However, again, undesirable organoleptic properties are expected.

EP3685673 discloses the use of alpha-amylase treated oats in chocolate. However, the use of the combination of single enzyme and single plant source, as well as no consideration of particle size, does not provide the required combination of product visual and textural properties.

Hence, the present invention seeks to solve the above-issues in chocolate product manufacture using at least a portion of milk ingredient replacement.

### SUMMARY OF THE INVENTION

The present invention provides a reduced dairy chocolate composition, which, surprisingly, preserves a milk alternative with no loss of favour and avoids grittiness and other unpleasant textural properties. In addition, it leads to short ingredient list using only natural ingredients.

Accordingly, the invention relates in general to a reduced dairy chocolate product, preferably a vegan chocolate product composition comprising a dried emulsion of a plant protein.

The present invention provides a chocolate product comprising a plant-based composition, said plant-based composition comprising (i) a plant protein, (ii) sugar, polyol, or one or more polysaccharides or mixtures thereof; (iv) optionally one or more emulsifiers; (v) a fat phase, wherein the weight ratio of plant protein to the total weight of sugar, polyol, or one or more polysaccharides and mixtures thereof is between 0.1:1 and 2.0:1 and the weight ratio of plant protein to fat is between 1.0:1.0 and 4.0:1.0.

In one embodiment, the chocolate product comprises between 1.0 wt % and 45.0 wt % of the plant-based composition based on the weight of the chocolate product.

In one embodiment, the chocolate product comprises between 0.2 wt % and 15.0 wt % of the plant protein based on the weight of the chocolate product.

In one embodiment, the plant protein materials used in the chocolate product composition are powders.

The inventors have surprisingly found that an emulsified plant protein can provide a milk alternative for a chocolate product composition, which is close to milk and which has the right balance between processability and organoleptic properties.

The invention also provides a method of making a chocolate product composition, preferably a vegan chocolate, comprising
a. Adding plant protein to water to form a plant protein mixture, preferably having a pH of between 6 and 9, preferably 6.7 and 8;
b. Adding sugar, polyol, or one or more polysaccharides or mixtures thereof to the plant protein mixture;
C. Optionally adding one or more emulsifiers to the plant protein mixture;
d. Dispersing a fat source in the plant protein mixture;
e. Homogenizing the plant protein mixture to form an emulsion;
f. Applying a thermal treatment to the emulsion to form a plant-based liquid;
g. Drying the plant-based liquid to form a plant-based composition; and
h. Combining the dry composition with other ingredients to form a chocolate product.

In one embodiment, the plant protein is provided as a powder or a flour.

In one embodiment, the plant protein is provided as a concentrate or an isolate. In one embodiment, the plant protein is not treated with an enzyme.

There is also provided a chocolate product composition made by a method according to the invention.

The use of the process of the present invention provides a taste improvement that is unexpected when replacing milk with plant proteins. The preferred use of legume protein and, in particular faba proteins, offers advantages in the taste (i.e. more akin to dairy-based chocolate). The methods for dairy replacement in the art do not offer this combination of advantageous benefits.

### DETAILED DESCRIPTION

### Plant-Based Composition

The process of the present invention provides a plant-based composition as an alternative to milk.

In a preferred embodiment, the plant-based composition comprises between 5 wt % and 45 wt % of a plant protein based on the dry weight of the plant-based composition, preferably between 10 wt % and 40 wt %, preferably between 15 wt % and 35 wt % and between 20 wt % and 30 wt %.

As discussed below, the plant protein may be provided in the form of a concentrate or an isolate.

The ranges below relate to the amount of each ingredient used, not the overall nutritional content.

In a preferred embodiment, the plant-based composition comprises between 10 wt % and 60 wt % of a plant protein concentrate or isolate based on the dry weight of the plant-based composition, preferably between 15 wt % and 55 wt %, preferably between 20 wt % and 50 wt % and between 25 wt % and 45 wt %.

In a preferred embodiment, the plant-based composition comprises between 20 wt % and 70 wt % of the total amount of sugar, polyol and/or polysaccharides based on the dry weight of the plant-based composition, preferably between 30 wt % and 65 wt %, preferably between 35 wt % and 60 wt % and between 40 wt % and 55 wt %.

In a preferred embodiment, the plant-based composition comprises between 5 wt % and 70 wt % of sugar based on the dry weight of the plant-based composition, preferably between 10 wt % and 60 wt %, preferably between 15 wt % and 50 wt % and between 15 wt % and 40 wt %.

In a preferred embodiment, the plant-based composition comprises between 5.0 wt % and 25.0 wt % or 5.0 wt % and 20.0 wt % of a fat based on the dry weight of the plant-based composition, more preferably between 6.0 wt % and 18.0 wt %, more preferably between 7.5 wt % and 17.0 wt % and most preferably between 8.5 wt % and 16.0 wt %. These percentages relate to the fat ingredient, not the total fat from all sources.

In a preferred embodiment, the plant-based composition comprises, based on the dry weight of the plant-based composition:
between 5 wt % and 45 wt % of a plant protein,
between 20 wt % and 70 wt % of the total amount of sugar, polyol and/or polysaccharides, and
between 5.0 wt % and 20.0 wt % of a fat.

In a preferred embodiment, the plant-based composition comprises, based on the dry weight of the plant-based composition:
between 15 wt % and 35 wt % of a plant protein,
between 35 wt % and 60 wt % of the total amount of sugar, polyol and/or polysaccharides, and
between 6.0 wt % and 18.0 wt % of a fat.

In a preferred embodiment, the plant-based composition comprises, based on the dry weight of the plant-based composition:
between 10 wt % and 60 wt % of a plant protein concentrate or isolate,
between 20 wt % and 70 wt % of the total amount of sugar, polyol and/or polysaccharides, and
between 5.0 wt % and 20.0 wt % of a fat.

In a preferred embodiment, the plant-based composition comprises, based on the dry weight of the plant-based composition:
between 20 wt % and 50 wt % of a plant protein concentrate or isolate,
between 35 wt % and 60 wt % of the total amount of sugar, polyol and/or polysaccharides, and
between 6.0 wt % and 18.0 wt % of a fat.

In a preferred embodiment, the plant protein; total amount of sugar, polyol and/or polysaccharides; and fat, based on the dry weight of the plant-based composition, constitute between 30 wt % and 100 wt % of the plant-based composition, more preferably between 45 wt % and 100 wt %, more preferably between 57.5 wt % and 95 wt % and more preferably between 68.5 and 90 wt %.

In a preferred embodiment, the plant protein concentrate or isolate; total amount of sugar, polyol and/or polysaccharides; and fat, based on the dry weight of the plant-based composition, constitute between 35 wt % and 100 wt % of the plant-based composition, more preferably between 51 wt % and 100 wt %, more preferably between 62.5 wt % and 98 wt % and more preferably between 68.5 and 95 wt %.

In a preferred embodiment, the weight ratio of plant protein to fat is between 0.5:1.0 and 4.0:1.0, preferably between 0.75:1 and 4.0:1.0, preferably between 1.0:1.0 and 4.0:1.0, preferably between 1.2:1.0 and 3.5:1.0 and more preferably 1.4:1.0 and 3.0:1.0.

In a preferred embodiment, the weight ratio of plant protein to the total weight of sugar, polyol, or one or more polysaccharides and mixtures is between 0.1:1 and 2.0:1, preferably between 0.2:1 and 1.5:1 and more preferably between 0.4:1 and 1.2:1.

In a highly preferred embodiment, the plant-based composition of the invention comprises a sugar selected from the group consisting of sucrose, fructose, glucose, dextrose, galactose, allulose, maltose, high dextrose equivalent hydrolysed starch syrup, xylose, and combinations thereof and an oil selected from the group consisting of sunflower oil, rapeseed (or canola) oil, olive oil, soybean oil, linseed oil, safflower oil, corn oil, cottonseed oil, grape seed oil, nut oils such as hazelnut oil, walnut oil, macadamia nut oil, peanut oil, rice bran oil, sesame oil, palm oil, high oleic sunflower oil, high oleic rapeseed, high oleic soybean oils & high stearin sunflower or combinations thereof.

In a highly preferred embodiment, the plant-based composition of the invention comprises a sugar selected from the group consisting of sucrose, fructose, glucose, dextrose, and combinations thereof and an oil selected from the group consisting of sunflower oil, rapeseed (or canola) oil, olive oil, hazelnut oil, walnut oil, macadamia nut oil, sesame oil, peanut oil, or combinations thereof.

In a preferred embodiment, the D90 particle size of the plant-based composition is less than 500 microns, preferably less than 400 microns and preferably less than 300 microns, preferably is less than 250 microns, preferably less than 200 microns, preferably less than 180 microns, and more preferably less than 175 microns.

These particle sizes relate to the composition in isolation, i.e. prior to incorporation, and the size when incorporated into the confectionery product. In certain embodiments, the mixing, refining and/or production process will reduce the particle size of the composition. Accordingly, preferably, in the chocolate product the plant-based composition D90 particle size is less than 300 microns.

In a preferred embodiment, the D90 particle size of the plant-based composition is greater than 25 microns, preferably is greater than 30 microns, preferably greater than 40 microns, preferably greater than 50 microns, and more preferably greater than 60 microns.

In a preferred embodiment, the D90 particle size of the plant-based composition is between 25 microns and 300 microns, preferably between 40 microns and 250 microns and more preferably between 60 microns and 200 microns.

In a preferred embodiment, the D50 particle size of the plant-based composition is less than 175 microns, preferably is less than 150 microns, preferably less than 125 microns, and preferably less than 100 microns.

In a preferred embodiment, the D50 particle size of the plant-based composition is greater than 5 microns, preferably is greater than 10 microns, preferably greater than 12 microns, preferably greater than 15 microns, and more preferably greater than 20 microns.

In a preferred embodiment, the D50 particle size of the plant-based composition is between 5 microns and 175 microns, preferably between 10 microns and 150 microns and more preferably between 15 microns and 100 microns.

### Plant Protein—Legume

A legume is a plant in the family Fabaceae (or Leguminosae), the seed of such a plant (also called pulse). Legumes are grown agriculturally, primarily for human consumption, for livestock forage and silage, and as soil-enhancing green manure.

The following legumes can be used in the chocolate product composition according to the invention: lentil, chickpea, beans, and peas, for example kidney beans, navy beans, pinto beans, haricot beans, lima beans, butter beans, azuki beans, mung beans, golden gram, green gram, black gram, urad, fava/faba beans, scarlet runner beans, rice beans, garbanzo beans, cranberry beans, green peas, snow peas, snap peas, split peas and black-eyed peas, groundnut, and Bambara groundnut.

Preferably, the legume is selected from lentil, chickpea, cow pea, faba bean, and green or yellow pea. Preferably the legume is pea or faba. Preferably, the legume is faba.

In a preferred embodiment, the plant protein does not comprise a mixture of different plant protein sources, i.e. preferably the plant protein is only from a legume, preferably a single legume.

In a preferred embodiment, the plant protein is provided as a concentrate or an isolate.

In a preferred embodiment, the plant protein is a faba or pea protein concentrate or isolate.

In a preferred embodiment, the plant protein concentrate or isolate comprises preferably between 40 wt % and 100 wt % protein, preferably between 50 wt % and 90 wt % or between 60 wt % and 80 wt %.

The wt % of protein in the confectionery of the invention is the wt % of actual protein, not the wt % of the protein concentrate or isolate that can be used to provide the protein. For example, when 1 wt % protein is required in the confectionery, 1.12 wt % of a protein isolate comprising 90 wt % protein can be used to provide the required 1 wt % protein. In another example, when 5 wt % protein is required in the confectionery, 6.25 wt % of a protein concentrate comprising 80 wt % protein can be used to provide the required 5 wt % protein.

In a preferred embodiment, the plant protein is not enzyme-treated. Preferably, the plant protein is not enzyme-treated in any of the process steps of the present invention, i.e. in any of steps a) to the drying steps. In this embodiment, it is preferred the plant protein is provided as a concentrate or an isolate.

In some embodiments, the plant protein material is wet fractionated or dry fractionated.

In some embodiments, the dry fractionated plant protein is an air classified plant protein.

In some embodiments, the dry fractionated plant protein has a starch fraction of less than 14 wt % on a dry basis, preferably between 5 and 14 wt % on a dry basis.

### Sugar, Polyol and Polysaccharides

The present invention utilizes sugar, polyol, or one or more polysaccharides or mixtures thereof in addition to the plant protein. In a preferred embodiment, these components are not derived from the plant source that provides the protein, i.e. are added as additional components.

In a preferred embodiment, the sugar is selected from the group consisting of sucrose, fructose, glucose, dextrose, galactose, allulose, maltose, high dextrose equivalent hydrolysed starch syrup, xylose, and combinations thereof.

In some embodiments, the sugar comprises a sugar syrup. Suitable sugar syrups include fully inverted sugar syrup, glucose syrup preferably at 20 to 98 Dextrose Equivalent (“DE”) or preferably at 25 to 70 DE, fructose glucose syrup (may also be termed glucose fructose syrup, isoglucose or fructose corn syrup), high fructose syrup, corn syrup, oat syrup, rice syrup carob extract syrup or tapioca syrup, or a mixture of any two or more of these syrups. In a preferred embodiment, the sugar comprises fully inverted sugar syrup, glucose syrup preferably at 20 to 98 Dextrose Equivalent (“DE”) or preferably at 25 to 70 DE, fructose glucose syrup (may also be termed glucose fructose syrup, isoglucose or fructose corn syrup), or high fructose syrup or a mixture of any two or more of these syrups.

When a syrup is added it may be added in hydrated or dehydrated form. In the plant-based composition, the syrup has preferably been dehydrated by the drying process used in the production of the composition.

In a preferred embodiment, the polyol is selected from the group consisting of sorbitol, mannitol, isomalt, maltitol, lactitol, xylitol, erythritol or glycerol or mixtures thereof.

In a preferred embodiment, the polysaccharide is selected from the group consisting of polydextrose, maltodextrin, inulin, cellulose, methylcellulose, pectin, soluble fibre (e.g. dextrin, for example Promitor®, Nutriose®), fructo-oligosaccharides, galacto-oligosaccharides and mixtures thereof.

In a preferred embodiment, step b. involves the addition of a sugar.

In a preferred embodiment, the weight ratio of plant protein to the weight of sugar in step b. is between 0.2:1 and 2.0:1, preferably between 0.2:1 and 2.0:1 and more preferably between 1.0:1 and 2.0:1.

In a preferred embodiment, step b. involves the addition of a mixture of a sugar and at least one polysaccharide, preferably one to three polysaccharides.

In a preferred embodiment, the sugar, polyol and/or polysaccharides is/are added at between 20 wt % and 70 wt % of the total solids, preferably between 30 wt % and 65 wt %, preferably between 35 wt % and 60 wt % and between 40 wt % and 55 wt %.

In a preferred embodiment, sugar, polyol and/or polysaccharides is/are added at an amount of between 20 wt % and 70 wt % of the non-aqueous ingredients (preferably the plant protein; sugar, polyol, or one or more polysaccharides or mixtures thereof; and fat), preferably between 30 wt % and 65 wt %, preferably between 35 wt % and 60 wt % and between 40 wt % and 55 wt %.

In a preferred embodiment, the weight ratio of plant protein to the total weight of sugar, polyol, or one or more polysaccharides and mixtures thereof in step b. is between 0.1:1 and 2.0:1, preferably between 0.2:1 and 1.5:1 and more preferably between 0.4:1 and 1.2:1. As noted in the examples section, the use of the above amounts of compounds assists in affording the desired flavour profile.

### Plant Flour and Treated Plant Protein

In an alternative embodiment, the plant protein is present in a plant flour, i.e. has not been concentrated or isolated from the original plant flour.

In this embodiment, the plant flour preferably requires an enzymatic treatment to ensure the necessary properties.

In a further embodiment, this enzymatic treatment may also be applied to the plant protein, preferably a concentrate or isolate as described above.

In a preferred embodiment, the enzyme treatment is carried out prior to fat addition to the plant protein mixture.

In one embodiment, when the plant flour or plant protein has been enzyme treated, the addition of external sugar, polyol or one or more polysaccharides or mixtures thereof is not required, i.e. the enzyme treatment provides the necessary amount of sugar or one or more polysaccharides.

In an alternative embodiment, the process may include enzyme treatment and addition of external sugar, polyol or one or more polysaccharides or mixtures thereof.

In a preferred embodiment, the enzyme treatment is carried out using an amylase, preferably an alpha-amylase.

In a preferred embodiment, the enzyme or mixture of enzymes is used in an amount of between 0.001% and 1.0% of the weight of the aqueous composition, preferably between 0.0015% and 0.5%, more preferably between 0.002% and 0.25%.

In a preferred embodiment, the enzyme or mixture of enzymes is used in an amount of between 0.01% and 5.0% of the weight of the plant protein, preferably between 0.02% and 3.5%, more preferably between 0.05% and 2.0%.

In a preferred embodiment, the enzyme treatment step comprises treatment with at least two enzymes, for example between 2 and 5 enzymes or between 2 and 4 enzymes.

In a preferred embodiment, when more than one enzyme is used, the enzyme treatment steps may be sequential or concomitant. In a preferred embodiment, when more than two enzymes are used, the enzyme treatment steps may be sequential, concomitant or mixtures thereof (e.g. single enzyme treatment followed by treatment with mixture of two enzymes). In a preferred embodiment, there is no deactivation step between enzyme treatment steps. In a preferred embodiment, the enzyme treatment steps may be distinguished by temperature changes (e.g. the first enzyme treatment step may be carried out at a certain temperature, the next enzyme treatment step with a different enzyme may be carried out a lower temperature).

In a preferred embodiment, the enzyme treatment occurs at temperature between 30° C. and 120° C., preferably between 35° C. and 110° C., more preferably between 40° C. and 100° C. and most preferably between 45° C. and 95° C. In a preferred embodiment, when there is more than one enzyme treatment step, all enzyme treatment steps occur within the above temperature ranges, but do not necessarily all have to occur at the same temperature.

In a preferred embodiment, at least one enzyme treatment step occurs at a temperature between 40° C. and 70° C.

In a highly preferred embodiment, the process comprises at least one enzyme treatment step at a temperature between 40° C. and 70° C. (for example, two enzyme treatment steps) and one enzyme treatment step occurs at a temperature between 50° C. and 100° C.

The difference in treatment steps may be the addition of a further enzyme, change in temperature etc.

In an embodiment, the treatment process with an enzyme is carried out for between 1 minutes and 20 hours, between 2 minutes and 10 hours, 20 minutes and 8 hours, between 30 minutes and 6 hours, between 45 minutes and 4 hours, between 1 hour and 3 hours or between 65 minutes and 2.5 hours.

In a preferred embodiment, when there is more than one enzyme treatment step, the duration of each enzyme treatment step occurs within the above time ranges but do not necessarily all have to occur for the same duration and/or the entire treatment duration is within the above ranges.

The enzyme used may be
alpha amylase;
alpha amylase, beta glucanase and a protease;
an alpha amylase having beta glucanase activity; or
an alpha amylase having beta glucanase activity and glucosidase.

In a preferred embodiment, the amylase is an alpha-amylase.

In a preferred embodiment, an additional enzyme is selected from:
protease;
glucosidase, preferably amyloglucosidase;
glucoamylase;
glucanase, preferably a beta glucanase and mixtures thereof.

Highly preferred enzyme combinations are:
amylase and glucosidase;
amylase and protease;
amylase and glucanase;
amylase, glucosidase, glucanase and protease; or amylase, glucanase and protease.

Specific preferred embodiments of the above are:
alpha amylase and amyloglucosidase;
alpha amylase and protease;
alpha amylase and beta glucanase;
alpha amylase, amyloglucosidase, beta glucanase and protease; or alpha amylase, beta glucanase and protease.

Amylase (EC 3.2.1.1) is an enzyme classified as a saccharidase: an enzyme that cleaves polysaccharides. It is mainly a constituent of pancreatic juice and saliva, needed for the breakdown of long-chain carbohydrates such as starch, into smaller units. Amyloglucosidase (EC 3.2.1.3) is an enzyme able to release glucose residues from starch, maltodextrins and maltose by hydrolysing glucose units from the non-reducing end of the polysaccharide chain. The sweetness of the preparation increases with the increasing concentration of released glucose. Proteases are enzymes allowing the hydrolysis of proteins. They may be used to decrease the viscosity of the hydrolysed whole grain composition. Alcalase 2.4 L (EC 3.4.21.62), from Novozymes is an example of a suitable enzyme. Glucanases (EC 3.2.1) are enzymes that break down a glucan, a polysaccharide made of several glucose sub-units. As they perform hydrolysis of the glucosidic bond, they are hydrolases. β-1,3-glucanase, an enzyme that breaks down β-1,3-glucans such as callose or curdlan. β-1,6 glucanase, an enzyme that breaks down β-1,6-glucans. Cellulase, an enzyme that perform the hydrolysis of 1,4-beta-D-glucosidic linkages in cellulose, lichenin and cereal β-D-glucans. Xyloglucan-specific endo-beta-1,4-glucanase. Xyloglucan-specific exo-beta-1,4-glucanase.

In a preferred embodiment, the cereal is treated with an enzyme mixture comprising alpha amylase and glucanase and the legume treated with a mixture of alpha amylase, amyloglucosidase and protease.

In a preferred embodiment, the enzyme or mixture of enzymes is used in an amount of between 0.010% and 10% of the weight of the substrate, preferably between 0.02% and 5%, more preferably between 0.02% and 1.0%.

In a preferred embodiment, the amount of each individual amylase, preferably alpha-amylase, used is in an amount of between 0.010% and 2.5% of the weight of the substrate, preferably between 0.015% and 1.0%, more preferably between 0.020% and 0.5%.

In a preferred embodiment, the amount of each individual protease is in an amount of between 0.020% and 2.0% of the weight of the substrate, preferably between 0.025% and 1.0%, more preferably between 0.03% and 0.50% and more preferably between 0.03% and 0.10%.

In a preferred embodiment, the amount of each individual glucosidase, preferably amyloglucosidase, is present in an amount of between 0.1% and 5.0% of the weight of the substrate, preferably between 0.20% and 2.5%, more preferably between 0.25% and 1.5% and more preferably between 0.30% and 1.0%.

In a preferred embodiment, the amount of each individual glucanase, preferably beta glucanase, is present in an amount of between 0.01% and 2.0% of the weight of the substrate, preferably between 0.015% and 1.0%, more preferably between 0.017% and 0.5% and more preferably between 0.020% and 0.2%.

### Fat

In a preferred embodiment, the fat source comprises an oil.

In a preferred embodiment, the lipid component is an oil at ambient conditions. The term “oil” has its standard definition, specifically a fat that is fluid at ambient conditions, i.e. a substance that has no fixed shape and yields to external pressure.

In a preferred embodiment, the solid fat content (SFC) of the fat blend is measured using IUPAC 2.150a at 20° C. A liquid fat preferably has a solid fat content of less than 15% by weight, preferably less than 10% by weight, preferably less than 7.5% by weight, preferably 5% by weight, preferably less than 2.5% by weight and preferably less than 0.5% by weight, i.e. 0.0 wt %, measured using IUPAC 2.150a at 20° C. For example, between 0.0 wt % and 15 wt %.

In a preferred embodiment, the lipid component is an oil at ambient conditions. In a preferred embodiment, the lipid component is selected from the group consisting of sunflower oil, rapeseed oil (or canola oil, the terms are synonymous), olive oil, soybean oil, hemp oil, linseed oil, safflower oil, corn oil, cottonseed oil, grape seed oil, nut oils such as hazelnut oil, walnut oil, rice bran oil, sesame oil, peanut oil, palm oil, palm kernel oil, coconut oil, and emerging seed oil crops such as 25 high oleic sunflower oil, high oleic rapeseed, high oleic palm, high oleic soybean oils & high stearin sunflower or combinations thereof.

In a preferred embodiment, the oil is selected from the group consisting of sunflower oil, rapeseed oil, olive oil, soybean oil, linseed oil, safflower oil, corn oil, cottonseed oil, grape seed oil, nut oils such as hazelnut oil, walnut oil, macadamia nut oil, or other nut oil, peanut oil, rice bran oil, sesame oil, palm oil, palm kernel oil, coconut oil, and emerging seed oil crops such as 25 high oleic sunflower oil, high oleic rapeseed, high oleic palm, high oleic soybean oils & high stearin sunflower or combinations thereof.

In a preferred embodiment, the oil component is selected from the group consisting of sunflower oil, rapeseed (or canola) oil, olive oil, hazelnut oil, walnut oil, macadamia nut oil, sesame oil, peanut oil, or combinations thereof.

In a highly preferred embodiment, the oil component is selected from the group consisting of sunflower oil, olive oil, hazelnut oil, walnut oil, macadamia nut oil, sesame oil, peanut oil, or combinations thereof.

In a highly preferred embodiment, the oil component comprises sunflower oil.

Preferably, a vegetable oil is used, more preferably an oil with a low SFA content is chosen such as high oleic sunflower oil or high oleic rapeseed oil.

The above liquid oils may have differing oleic acid contents. For example, sunflower oil may be (% by weight): Conventional oil or high linoleic acid: 14.0%<Oleic acid<43.1%, Mid Oleic: 43.1%≤Oleic acid<71.8%, High oleic: 71.8%≤Oleic acid<90.7%, Ultra/Very-high oleic, 90.7≤oleic acid. For example, safflower oil:conventional oil: 8.4%<Oleic acid<21.3%; and High oleic: 70.0%<Oleic acid<83.7%. Additionally, high oleic acid variants of the following oils are available, soybean oil (70.0%≤Oleic acid<90.0%), rapeseed oil (70.0%≤Oleic acid<90.0%)/canola (70.0%≤Oleic acid<90.0%), olive oil (70.0%≤Oleic acid<90.0%), and algae oil (80.0%≤Oleic acid<95.0%).

In a highly preferred embodiment, the oil component has a percentage of medium chain fatty acids (preferably caproic, caprylic, capric, lauric and myristic) between 0% and 10% medium chain fatty acids, preferably between 0% and 9%, preferably between 0% and 7.5%.

In a highly preferred embodiment, the oil component has a percentage of long chain fatty acids (preferably palmitic, palmitoleic, stearic, oleic and linoleic) between 80% and 100% long chain fatty acids, preferably between 90% and 99.5%, preferably between 92% and 99%.

In a highly preferred embodiment, the oil component has a percentage of saturated fatty acids of between 0% and 40%, more preferably between 0% and 30% and more preferably between 2% and 20%.

In a highly preferred embodiment, the oil component has percentage of polyunsaturated fatty acids of between 10% and 90%, more preferably between 15% and 80% and more preferably between 20% and 70%.

The above percentages relate to percentages of the total fatty acid profile. The fatty acid profile may be assessed by methods known in the art. In a preferred embodiment, the fatty acid oil is measured using AOAC 969.33.

In some embodiments, the fat component from the oilseed mentioned above may be replaced or supplemented by a fat used in confectionery production, preferably chocolate production.

In a further embodiment, the confectionery fat may be added as a liquid or solid.

In a preferred embodiment, the fat may be cocoa butter (CB), cocoa butter equivalents (CBE), cocoa butter replacers (CBR) and/or cocoa butter substitutes (CBS). Such products may generally comprise one or more fat(s) selected from the group consisting of: lauric fat(s) (e.g. cocoa butter substitute (CBS) obtained from the kernel of the fruit of palm trees); non-lauric vegetable fat(s) (e.g. those based on palm or other specialty fats); cocoa butter replacer(s) (CBR); cocoa butter equivalent(s) (CBE) and/or any suitable mixture(s) thereof. Some CBE, CBR and especially CBS may contain primarily saturated fats and very low levels of unsaturated omega three and omega six fatty acids (with health benefits). Thus, in one embodiment in chocolate product confectionery of the invention such types of fat are less preferred than CB.

In a further embodiment, the fat in or between the processing steps b. to e. In a preferred embodiment, the fat is added directly prior or during the homogenization step.

In a preferred embodiment the fat is added at an amount of between 1.0 wt % and 25.0 wt % or 1.0 wt % and 20.0 wt % of the non-aqueous ingredients (preferably the plant protein; sugar, polyol, or one or more polysaccharides or mixtures thereof; and fat), preferably between 5.0 wt % and 20.0 wt %, more preferably between 6.0 wt % and 18.0 wt %, more preferably between 7.5 wt % and 17.0 wt % and most preferably between 8.5 wt % and 16.0 wt %.

In a preferred embodiment the fat is added at an amount of between 1.0 wt % and 25.0 wt % or 1.0 wt % and 20.0 wt % of the total solids, preferably between 5.0 wt % and 20.0 wt %, more preferably between 6.0 wt % and 18.0 wt %, more preferably between 7.5 wt % and 17.0 wt % and most preferably between 8.5 wt % and 16.0 wt %.

As shown in the examples section, the use of fat afforded masking of an off flavours, e.g. “earthy”, “green” etc. plant-based off flavours. The most optimal range was found be between 8.5 wt % and 16.0 wt % and when using 10 wt % or 15 wt % fat the flavours were masked.

In a preferred embodiment, the weight ratio of plant protein to fat is between 0.5:1.0 and 4.0:1.0, preferably between 0.75:1 and 4.0:1.0, preferably 1.0:1.0 and 4.0:1.0, preferably between 1.2:1.0 and 3.5:1.0 and more preferably 1.4:1.0 and 3.0:1.0. As shown in the examples section, working within these ranges affords masking of the off flavours associated with plant-based ingredients.

### Particle Size Definition

D90 (for the volume weighted distribution) is the diameter of particle, for which 90% of the volume of particles have a diameter smaller than this D90.

D50 (for the volume weighted distribution) is the diameter of particle, for which 50% of the volume of particles have a diameter smaller than this D90. The particle size distribution (weighted in volume) for a powder can be determined by automatized microscopy technique or by static light scattering.

The particle size distribution is preferably measured by laser light diffraction, e.g. using a Mastersizer 3000, Malvern Instruments Ltd, Malvern UK with Fraunhoffer theory or Mie theory (absorption index 0.01, RI sucrose 1.538) in a “wet system” using a Hydro SM attachment and AAK Akomed R MCT oil dispersant RI 1.45. In a “wet system”, the sample is placed in the MCT oil and sonicated for 2 minutes with an ultrasonic probe before being run in the Malvern 3000 with a Hydro SM wet dispersion unit, in duplicate. In a “dry system”, the sample is placed into the Aero S automatic dry dispersion unit before being run in the Malvern 3000, in duplicate.

The particle sizes obtained using the above methods were not significantly different for the present invention. However, preferably, a Mie theory, dry system is used, as in the examples.

### Definitions

According to the present invention, the terms “chocolate product” and “chocolate analogue product” identify respectively chocolate or chocolate analogue based products (also conventionally known as “compound”) as well as couverture. Chocolate and chocolate analogue products of the invention include but are not limited to: a chocolate product, a chocolate analogue product (e.g. comprising cocoa butter replacers, cocoa-butter equivalents or cocoa-butter substitutes), a chocolate coated product, a chocolate analogue coated product, a chocolate coating for biscuits, wafers or other confectionery items, a chocolate analogue coating for biscuits, wafers or other confectionery items and the like.

The term ‘chocolate’ as used herein denotes any product (and/or component thereof if it would be a product) that meets a legal definition of chocolate in any jurisdiction and also include product (and/or component thereof) in which all or part of the cocoa butter (CB) is replaced by cocoa butter equivalents (CBE) and/or cocoa butter replacers (CBR).

The term ‘chocolate compound’ as used herein (unless the context clearly indicates otherwise) denote chocolate-like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids.

The term ‘chocolate product’ as used herein denote chocolate, compound and other related materials that comprise cocoa butter (CB), cocoa butter equivalents (CBE), cocoa butter replacers (CBR) and/or cocoa butter substitutes (CBS). Thus, chocolate product includes products that are based on chocolate and/or chocolate analogues, and thus for example may be based on dark, milk or white chocolate.

In a preferred embodiment, ingredients of the chocolate product comprise cocoa butter, cocoa mass, cocoa butter equivalents, cocoa butter replacers, cocoa butter substitutes and/or sweeteners.

In the present invention, the chocolate product composition comprises at least 1.0 wt % based on the weight of the chocolate product of the plant-based composition.

In a preferred embodiment, the chocolate product composition comprises at least 2.0 wt % based on the weight of the chocolate product of a composition comprising a mixture of the plant-based composition, preferably at least 5.0 wt % and preferably at least 10.0 wt %.

In a preferred embodiment, the chocolate product composition comprises less than 50.0 wt % based on the weight of the chocolate product of the plant-based composition, preferably less than 40.0 wt % and preferably less than 30.0 wt % and preferably less than 25.0 wt %.

In a preferred embodiment, the content of the plant-based composition is between 1.0 wt % and 50.0 wt %, preferably between 2.0 wt % and 40.0 wt %, preferably between 5.0 wt % and 30.0 wt % and most preferably between 10.0 wt % and 25.0 wt % of the chocolate product. The present invention may provide a vegan chocolate product as discussed. Alternatively, the present invention provides in an embodiment a partial replacement of the milk products traditionally used in chocolate. Accordingly, in an embodiment, the plant-based composition is added to the chocolate product to at least partially replace the milk product ingredient of the chocolate. Accordingly, in an embodiment, the replacement is between 10 wt % and 100 wt % of milk product ingredients in the chocolate material, preferably between 25 wt % and 100 wt %, preferably between 50 wt % and 100 wt %, preferably between 75 wt % and 100 wt %.

In an embodiment, the chocolate product, of the present invention comprises cocoa butter (or equivalent as described above) by weight of the confectionery material in at least 5.0% by weight, preferably at least 10.0% by weight, preferably at least 13.0% by weight, more preferably at least 15.0% by weight, for example at least 17.0% or at least 20%.

The preferred maximum amount of cocoa butter (or equivalent as described above) present in the chocolate product of the present invention is less than 50.0 wt % or less than 40.0% by weight, preferably not more than 35.0% by weight, more preferably not more than 30.0% by weight, and most preferably not more than 25.0% cocoa butter by weight of the chocolate product. For example, between 10.0 wt % and 35.0 wt % of the chocolate product.

In an embodiment, the chocolate product comprises between 0% and 95% by weight of the confectionery product of cocoa mass dependent on the end product, preferably between 0% and 85%, for example, between 45% and 80%, less than 5% or between 8% and 20% by weight of the chocolate product of cocoa mass.

Generally, the chocolate product of the present invention comprises at least 5.0 wt % by weight, preferably at least 10.0% by weight, preferably at least 13.0% by weight, at least 15.0% by weight, and or at least 17.0% cocoa mass by weight of the chocolate product.

The preferred maximum amount of cocoa mass present in the chocolate product of the present invention is less than 35.0% by weight, preferably not more than 30.0% by weight, by weight, and most preferably not more than 25.0% cocoa mass by weight. For example, between 5.0 wt % and 35.0 wt % of the chocolate product.

If the chocolate product is a white chocolate product, the amount of cocoa mass is lower than that above, preferably not present.

In an embodiment of the present invention, the chocolate product comprises a milk-based component, preferably the milk-based component is selected from the group consisting of non-fat milk solids, milk powder (optionally full cream, skimmed or semi-skimmed) and milk fat and combinations thereof. This milk-based component may be present between 0 wt % and 60 wt %, optionally between 10 wt % and 50 wt % of the chocolate product.

In an alternative and preferred embodiment of the present invention, the chocolate product does not comprise any milk-based components.

In an embodiment of the present invention, the chocolate product comprises a sweetener, preferably in an amount of between 10 wt % and 80 wt % or preferably 10 wt % and 60 wt % of the chocolate product, and more preferably between 15 wt % and 55 wt %. In a preferred embodiment, the sweetener is sugar, preferably a mono- or di-saccharide, preferably sucrose.

A preferred embodiment of the present invention is a chocolate product comprising:
plant-based composition between 1.0 wt % and 50.0 wt %,
cocoa butter between 5.0 wt % and 50.0 wt %,
cocoa mass between 5.0 wt % and 35.0 wt %, and
sweetener between 10 wt % and 80 wt %.

In a more preferred embodiment, provided is a chocolate product comprising:
plant-based composition between 5.0 wt % and 30.0 wt %,
cocoa butter between 10.0 wt % and 35.0 wt %,
cocoa mass between 10.0 wt % and 30.0 wt %, and
sweetener between 10 wt % and 60 wt %.

In a preferred embodiment of the present invention, the cocoa butter, cocoa mass, sweetener and plant-based composition mentioned above provide between 75 wt % and 100 wt % of the chocolate product composition, preferably between 85 wt % and 100 wt % and preferably between 90 wt % and 99.5 wt %.

In an embodiment, the present invention comprises an emulsifier, optionally at least one emulsifier. There is no particular limitation on the selection of emulsifier and any suitable compound known in the art may be used.

Examples of suitable emulsifiers include lecithin derived from plant sources and sunflower lecithin is particularly preferred. The chocolate mass according to the invention preferably contains the at least one emulsifier in an amount in a range from 0.1 to 1.0% by weight, particularly preferably in a range from 0.3 to 0.6% by weight, based on the weight of the chocolate product.

In an embodiment, the chocolate product may also comprise additional lipid components. In a preferred embodiment, the lipid component is selected from the group consisting of sunflower oil, rapeseed oil, olive oil, soybean oil, linseed oil, safflower oil, corn oil, cottonseed oil, grape seed oil, nut oils such as hazelnut oil, almond oil, walnut oil, macadamia nut oil, or other nut oil, peanut oil, rice bran oil, sesame oil, peanut oil, palm oil, palm kernel oil, coconut oil, and emerging seed oil crops such as 25 high oleic sunflower oil, high oleic rapeseed, high oleic palm, high oleic soybean oils & high stearin sunflower or combinations thereof.

Preferred vegetable oils are sunflower oil or a nut oil, with hazelnut oil and almond oil being preferred nut oils and hazelnut oil being a particularly preferred oil. The lipid component may be in the form of a paste. A preferred paste contains the above seeds, sprouts or fruits of plants or mixtures thereof in crushed, ground, crushed or chopped up form.

The amount of additional lipid components is preferably in a range from 1.0 to 15.0% by weight, particularly preferably in a range from 5.0 to 10% 0.0 by weight of the chocolate product.

The chocolate or chocolate analogue product may be in form of a moulded tablet, a moulded bar, an aerated product, or a coating for confectionery products, wafer, biscuits, among others. It may also have inclusions, chocolate layers, chocolate nuggets, chocolate pieces, chocolate drops. The chocolate or chocolate analogue product may further contain crispy inclusions e.g. cereals, like expanded or toasted rice or dried fruit pieces.

### Process

The present invention provides a method of making a chocolate product composition, preferably a vegan chocolate, comprising:
a. Adding plant protein to water to form a plant protein mixture, preferably having a pH of between 6 and 9, preferably 6.7 and 8;
b. Adding sugar, polyol, or one or more polysaccharides or mixtures thereof to the plant protein mixture;
c. Optionally adding one or more emulsifiers to the plant protein mixture;
d. Dispersing a fat source in the plant protein mixture;
e. Homogenizing the plant protein mixture to form an emulsion;
f. Applying a thermal treatment to the emulsion to form a plant-based liquid;
g. Drying the plant-based liquid to form a plant-based composition; and
h. Combining the dry composition with other ingredients to form a chocolate product.

The present invention preferably utilizes plant protein concentrate or isolate in step a.

In an embodiment, the mixture is treated to increase the pH, for example, the mixture is treated with an alkaline salt or base. The nature of the compound is not particularly limited, but is preferably a food-grade compound. In a preferred embodiment, the mixture is treated with compound such as mono-/di-/tri-sodium-/potassium-/calcium-phosphates, mono-/di-ammonium phosphate, sodium hydroxide, calcium hydroxide, potassium hydroxide, sodium carbonate, calcium carbonate, or potassium carbonate and mixtures thereof in order to increase the pH. The pH is measured at 20° C.

For step a., the plant protein is preferably diluted in water to 5.0 to 50.0 wt % based on the weight of water, preferably from 10.0 to 45.0% based on the weight of the water used, preferably between 15.0 and 40%, more preferably between 20.0 and 40.0%, to yield an aqueous composition.

In the present invention, the addition of the ingredients to the water is not limiting, steps a. to d. may be interchanged, i.e. the order is not limiting.

In an embodiment, a buffer or a buffer salt may be used.

For example, sodium ascorbate, can be added to. In some embodiments, sodium ascorbate is dissolved in the plant protein mixture. Preferably, sodium ascorbate is dissolved in the plant protein mixture or emulsion. In some embodiments, sodium ascorbate or a sodium ascorbate alternative may be used.

In some embodiments, a phosphate source is dissolved in the plant protein mixture. Preferably, the phosphate source comprises tricalcium phosphate and dipotassium phosphate.

Sodium ascorbate alternatives include vitamin C, sodium ascorbate, calcium ascorbate, vitamin C palmitate, fruit juices rich in vitamin C (≥500 mg vitamin C per 100 mL), acerola extract, sodium bisulfite, iodine, potassium iodide, sorbic acid, potassium sorbate, sulfite derivatives such as sodium sulfite, sodium hydrogen sulfite, sodium metabisulfite, potassium metabisulfite, calcium sulfite, and calcium hydrogen sulfite.

Buffer alternatives include dipotassium phosphate, trisodium citrate, tripotassium citrate, tripotassium phosphate, sodium bicarbonate, baking soda, bicarbonate of soda, disodium phosphate, trisodium phosphate, monopotassium phosphate, citric acid, lemon juice. Calcium sources buffers include tricalcium phosphate, calcium carbonate, calcium glycerolphosphate, and calcium citrate.

The homogenization step comprises at least one homogenization step. In a preferred embodiment, there are two homogenization steps. At least one of the homogenization steps is carried out, preferably, at a pressure of between 200 bar and 500 bar, preferably between 250 bar and 350 bar. In a further embodiment, the further homogenization step is carried out between 25 bar and 100 bar, preferably between 30 bar and 75 bar.

Preferably, the homogenization includes valve homogenization, micro-fluidization or ultrasonic homogenization.

The plant protein mixture is emulsified. In some embodiments, the emulsion is formed using a two-stage high pressure homogenizer.

A thermal treatment is applied to the emulsion to render it microbiologically stable as well as to reduce its viscosity. In some embodiments, the thermal treatment is ultra high temperature treatment (UHT).

A shear treatment may be applied to the thermal treated emulsion. In some embodiments, the shear treatment is applied using a high shear homogenizer. In some embodiments, the viscosity of the plant-based liquid after shear treatment is between 0.1 and 100 mPa·s, preferably less between 0.5 and 30 mPa·s, more preferably between 0.5 and 15 mPa·s at a shear rate of 10 s⁻¹ at 25° C.

In an embodiment, prior to drying, a concentration step is present. In the embodiment where concentration is present, the concentration is carried out by known methods, e.g. evaporation, to preferably reach a target viscosity and/or total solids content. For example, the total solids may be within the range of 15% to 60%, preferably 20% to 50%. For example, the target viscosity of 80 mPa s to 120 mPa s, preferably 100 mPa s (60° C. and 600 1/s, as measured using the method specified below).

In the above embodiment, the sterilization or pasteurisation step relates to treatment at high temperatures (typically 120° C. to 160° C.) for a very short period (typically no more than 200 seconds and optionally typically more than 50 seconds) to deactivate any microbial contaminants to make the ingredient safe for human consumption. Alternatively, different temperatures may be used, for example, 60° C. to 100° C., and different times, for example 60 to 500 seconds. The thermal treatment step is not particularly limited, as long as pasteurisation occurs without product degradation.

In one embodiment, drying is performed by spray drying, roller drying, belt drying, vacuum belt drying, spray freezing, spray chilling, ray drying, oven drying, convection drying, microwave drying, freeze drying, pulsed electric field assisted drying, ultrasound assisted drying, fluid bed drying, ring drying, vortex drying, or IR drying (radiation).

In a preferred embodiment, drying is performed by spray drying, roller dryer, belt drying, or vacuum belt drying.

In a preferred embodiment, the moisture, preferably water, content is measured using Karl Fischer analysis, Orion 2 Turbo with methanol:formamide 2:1 or a halogen moisture analyser (e.g. a Mettler-Toledo balance) or weight loss in an oven, 5 g sample for 5 hours at 102° C., preferably by Karl Fischer analysis.

In a preferred embodiment, the plant-based composition comprises water in an amount of less than 15% by weight, preferably less than 10% by weight, preferably less than 8% by weight and most preferably less than 5% by weight. For example, between 0.0% and 15%, between 0.1% and 10% or between 0.2% and 8%, and most preferably between 0.2% and 5%.

### Definitions

When a composition is described herein in terms of wt %, this means a mixture of the ingredients on a dry basis, unless indicated otherwise.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

The end points of the ranges disclosed are considered to be within the scope of the range.

As used herein, an “analogue” of a substance is considered to be a parallel of that substance in regard to one or more of its major characteristics. A “milk analogue” as used herein will parallel milk in the major characteristics of purpose, usage, and nutrition. Preferably, the milk analogue is an analogue of cow's milk.

The term “vegan” refers to an edible composition which is entirely devoid of animal products, or animal derived products. Non-limiting examples of animal products include meat, eggs, milk, and honey.

The present invention will now be described with reference to the non-limiting examples below.

### EXAMPLES

### Reference Example 1

Ingredion FABA Concentrate—Vitessence Pulse 3600 or 3602 was used as a faba bean source. According to the manufacturer, it is 100% faba bean protein powder, derived from the dehulled split faba (or fava) bean cotyledons of faba (or fava) beans (Vicia faba)). It has maximum moisture content of 9%, minimum protein content of 60% (dry basis), minimum starch content of 4% (dry basis), and a maximum fat content of 4% (dry basis).

3.8 kg of faba concentrate was dissolved in 56.3 kg of water at 50° C. with stirring, to this was added 235 grams of tricalcium phosphate, 100 grams of dipotassium phosphate, and 2 kg of sucrose. This mixture was mixed at 50° C. for 30 minutes to ensure complete dissolution. The pH of the mixture was then adjusted to 7.5 with 1M NaOH. 1.7 kg of sunflower oil was then added to the mix then final volume made to 65 litres and the oil was coarsely dispersed using a rotor stator mixer. A fine emulsion was then created by passing through a two-stage high pressure homogeniser (400 bar/80 bar first/second stage homogenisation pressures). The product was rendered microbiologically stable by thermal treatment with an ultra-high temperature treatment (UHT) of 143° C., 5 seconds.

### Reference Example 2

3.8 kg of FABA bean protein concentrate (Ingredion vitessence 3600 or 3602) was dissolved in 56.3 kg of water at 50° C. with stirring, to this was added 235 grams of tricalcium phosphate, 100 grams of dipotassium phosphate, 2 kg of sucrose and 45 g of sodium ascorbate. This mixture was mixed at 50° C. for 30 minutes to ensure complete dissolution. The pH of the mixture was then adjusted to 7.5 with 1M NaOH. 1.7 kg of oil was then added to the mix then final volume made to 65 litres and the oil was coarsely dispersed using a rotor stator mixer. A fine emulsion was then created by passing through a two-stage high pressure homogeniser (400 bar/80 bar first/second stage homogenisation pressures). The product was rendered microbiologically stable by thermal treatment with an ultra-high temperature treatment (UHT) of 143° C., 5 seconds. The product was then passed through a rotor stator homogeniser (Silverson Verso-1.6 mm round mesh double stage) which was placed just after the UHT cooling tubes and before the filling station. The resulting product was cream in colour, had a much lower viscosity/texture compared to Reference Example 1 product.

### Example 3

The following powders were prepared using the below method:
1. Dissolution of sucrose, carrier (polydextrose, Glucose Syrup DE 29), ascorbic acid
2. Dissolution of faba concentrate
3. pH adjustment to 7.1 using NaOH
4. Addition of oil
5. Homogenization-300/50 bars
6. Pasteurization at 80° C. for 46 sec
7. Homogenization-300/50 bars
8. Spray drying

| 3a - Ingredient | Powder dry % |
|---|---|
| FABA protein concentrate [>60% Protein] | 34.56 |
| Na Ascorbate | 0.44 |
| Polydextrose | 28 |
| Sucrose | 20 |
| High oleic sunflower oil | 17 |
| NaOH solution (0.5 mol) | 0.3 |

| 3b - Ingredient | Powder dry % |
|---|---|
| FABA protein concentrate [>60% Protein] | 34.2% |
| Na Ascorbate | 0.4% |
| Glucose Syrup DE 29 | 25.9% |
| Dipotassium Phosphate Powder INS340 | 1.8% |
| trisodium citrate | 1.5% |
| Sucrose | 18.2% |
| Tricalcium phosphate | 2.2% |
| High oleic sunflower oil | 15.8% |

| 3c - Ingredient | Powder dry % |
|---|---|
| FABA protein concentrate [>60% Protein] | 36.00% |
| Na Ascorbate | 0.42% |
| Glucose Syrup DE 29 | 27.80% |
| high oleic Sunflower oil | 15.76% |
| Sucrose | 20.00% |

The above solids contributed to 35 wt % of the aqueous mixture for each example, i.e. the remaining 65 wt % is water.

Example 3c was repeated with no ascorbic acid and 0% (Comparative Example 1), 5%, 10%, and 15% sunflower oil. The % amounts of the other ingredients was altered in line with these modifications.

### Example 4: Chocolate Recipes

Chocolate was prepared using 14 wt % cocoa liquor, 44 wt % sucrose, 21 wt % plant composition, 20 wt % cocoa butter, 0.56% lecithin and 0.03 vanilla.

### Production Process

1. Mixing of cocoa liquor, sucrose, plant composition and approximately 90% of the cocoa butter at 45° C.
2. Roll refining to 20-30 μm
3. Conching at 60° C. degrees for 5 hours, adding the lecithin, the rest of the cocoa butter and the vanilla
4. Sieving using a 400 μm mesh
5. Tempering at 27-29° C.
6. Moulding
7. Cooling at 8° C.
8. Demoulding

### Example 5

Four plant-based powders with an increasing amount of oil 0-15% were created following method in Example 3.

| | 5a- | 5b- | 5c- | 5d- |
|---|---|---|---|---|
| 5 - Plant-based | Powder | Powder | Powder | Powder |
| Ingredient | dry % | dry % | dry % | dry % |
| FABA protein concentrate | 42.70% | 40.60% | 38.50% | 36.78% |
| [>60% Protein] | | | | |
| Na Ascorbate | 0.50% | 0.50% | 0.50% | 0.42% |
| Glucose Syrup DE 29 | 33.00% | 31.40% | 29.70% | 27.80% |
| high oleic Sunflower oil | 0.00% | 5.00% | 10.00% | 15.00% |
| Sucrose | 23.70% | 22.60% | 21.40% | 20.00% |

The plant powders were incorporated into chocolate to understand the impact of oil concentration in the emulsion upon chocolate sensory characteristics. The chocolate recipes are shown below and were created following the process shown in Example 4.

| | 5e- | 5f- | 5g- | 5h- |
|---|---|---|---|---|
| 5 - Chocolate | Chocolate | Chocolate | Chocolate | Chocolate |
| recipes | % | % | % | % |
| Cocoa liquor | 14.00% | 14.00% | 14.00% | 14.00% |
| Sucrose | 44.00% | 44.00% | 44.00% | 44.00% |
| Plant composition | 18.00% | 19.00% | 20.00% | 21.00% |
| Cocoa butter | 23.41% | 22.41% | 21.41% | 20.41% |
| Lecithin | 0.56% | 0.56% | 0.56% | 0.56% |
| Vanilla | 0.03% | 0.03% | 0.03% | 0.03% |

The chocolates were tasted by a non-trained group of panelists at room temperature (20° C.), allowing a 2-minute rest in between samples, besides drinking water to rinse their palate. The panelists described sensory attributes of the samples, in their own words for flavour and texture attributes. Some of these attributes are cocoa, milky, beany, earthy, carboard, hardness, melting time.

Chocolate samples with less than 10% oil present in the plant emulsion composition, were perceived as having beany or earthy green notes. This off-notes were more pronounced when no oil (0%) was present. When the oil level increased from 5 to 10% oil in the plant composition, an increased effect of the oil in masking beany notes from bean or legume was observed. This flavour improvement in plant-based chocolates was achieved without any flavour additions or maskers in the plant or the chocolate composition. Furthermore, all samples with ≥10% oil in the plant composition provided a higher milkiness, closer to a milk chocolate reference sample. No big differences were seen in flavour improvements of chocolate with plant compositions with and oil content between 10 and 15%.

Texture of the chocolate was good in all the samples, irrespective of the oil content, with no real difference in terms of hardness or time to melt in mouth.

With regards to texture, it has not been seen any bloom over shelf life (>9 months)

### Example 6a and Comparative Examples 6b and 6c

Three chocolate recipes were manufactured varying the fat type used, to indicate whether the effect of replacing High Oleic Sunflower Oil for CBE in the plant composition may have an impact on flavour and texture of chocolate. 6a is a reference chocolate using the plant composition. 6b mimicked the plant composition in the chocolate recipe. 6c replaced the HOSFO with CBE in the chocolate recipe. using an CBE instead of High Oleic Sunflower Oil (Recipes 6a and 6c), The chocolate recipes are shown below and were created following the process shown in Example 4.

| | 6a- | 6b- | 6c- |
|---|---|---|---|
| 6 - Chocolate | Chocolate | Chocolate | Chocolate |
| recipes | % | % | % |
| Cocoa liquor | 13.00% | 13.00% | 14.00% |
| Sucrose | 43.73% | 54.80% | 54.06% |
| Plant composition | 22.00% | 0.00% | 0.00% |
| FABA protein | 0.00% | 7.75% | 7.75% |
| concentrate [>60% | | | |
| Protein] | | | |
| Cocoa butter | 17.17% | 20.20% | 20.20% |
| CBE | 3.51% | 0.00% | 3.40% |
| High Oleic Sunflower | 0.00% | 3.40% | 0.00% |
| Oil | | | |
| Lecithin | 0.56% | 0.56% | 0.56% |
| Vanilla | 0.03% | 0.03% | 0.03% |

The chocolates were tasted by a non-trained group of panelists at room temperature (20° C.), allowing a 2-minute rest in between samples, besides drinking water to rinse their palate. The panelists described sensory attributes of the samples, in their own words for flavour and texture attributes. Some of these attributes are cocoa, milky, beany, earthy, carboard, metallic, hardness, melting time.

Tasters described chocolate samples 6b and c as having a beany, earthy and metallic taste. These attributes were not perceived in reference sample 6a. This flavour differences are showing once again the unique attributes that the emulsion plant composition has on improving taste towards that of a characteristic milk chocolate.

With regards to the effect of the CBE versus HOSFO on melting behaviour of chocolate, it was seen that sample 6c provided a softer and better melting behaviour than sample 6a and 6b. This suggests it will be possible to replace the oil in the emulsion plant composition to generate an improved sensory delivery both in flavour and texture of plant-based chocolate.

1. A method of making a chocolate product, said method comprising
a. Adding plant protein to water to form a plant protein mixture;
b. Adding sugar, polyol, or one or more polysaccharides or mixtures thereof to the plant protein mixture;
c. Dispersing a fat source in the plant protein mixture;
d. Homogenizing the plant protein mixture to form an emulsion;
e. Applying a thermal treatment to the emulsion to form a plant-based liquid;
f. Drying the plant-based liquid to form a plant-based composition; and
g. Combining the dry composition with other ingredients to form a chocolate product.

2. The method according to claim 1, wherein plant protein is derived from a legume source.

3. The method according to claim 1, wherein the plant protein is a concentrate or an isolate.

4. The method according to claim 1, wherein step b. involves the addition of a mixture of a sugar and at least one polysaccharide.

5. The method according to claim 1, wherein the sugar is selected from the group consisting of sucrose, fructose, glucose, dextrose, galactose, allulose, maltose, high dextrose equivalent hydrolysed starch syrup, xylose, and combinations thereof.

6. The method according to claim 1, wherein the polyol is selected from the group consisting of sorbitol, mannitol, isomalt, maltitol, lactitol, xylitol, erythritol or glycerol.

7. The method according to claim 1, wherein the polysaccharide is selected from the group consisting of polydextrose, maltodextrin, inulin, cellulose, methylcellulose, pectin, soluble fibre (e.g. dextrin), fructo-oligosaccharides, galacto-oligosaccharides and mixtures thereof.

8. The method according to claim 1, wherein the fat source comprises an oil.

9. The method according to claim 8, wherein the oil is selected from the group consisting of sunflower oil, rapeseed oil, olive oil, soybean oil, linseed oil, safflower oil, corn oil, cottonseed oil, grape seed oil, nut oils such as hazelnut oil, walnut oil, macadamia nut oil, or other nut oil, peanut oil, rice bran oil, sesame oil, palm oil, palm kernel oil, coconut oil, and emerging seed oil crops such as 25 high oleic sunflower oil, high oleic rapeseed, high oleic palm, high oleic soybean oils and high stearin sunflower and combinations thereof.

10. The method according to claim 1, wherein the weight ratio of plant protein to the total weight of sugar, polyol, or one or more polysaccharides and mixtures thereof in step b. is between 0.1:1 and 2.0:1, preferably between 0.2:1 and 1.5:1 and more preferably between 0.4:1 and 1.2:1.

11. The method according to claim 1, wherein the weight ratio of plant protein to fat in step c. is between 1.0:1.0 and 4.0:1.0.

12. (canceled)

13. A chocolate product comprising a plant-based composition, said plant-based composition comprising (i) a plant protein; (ii) sugar, polyol, or one or more polysaccharides or mixtures thereof; a fat phase, wherein the weight ratio of plant protein to the total weight of sugar, polyol, or one or more polysaccharides and mixtures thereof in is between 0.1:1 and 2.0:1 and the weight ratio of plant protein to fat is between 1.0:1.0 and 4.0:1.0.

14. The chocolate product according to claim 13, wherein the chocolate product comprises between 1.0 wt % and 45.0 wt % of the plant-based composition based on the weight of the chocolate product.

15. The chocolate product according to claim 13, wherein the chocolate product comprises between 0.2 wt % and 15.0 wt % of the plant protein based on the weight of the chocolate product.

16. The chocolate product according to claim 13, wherein the chocolate product is devoid of animal products.

17. The chocolate product according to claim 13, wherein the chocolate product comprises between 0.1 wt % and 7.5 wt % of the polysaccharide.
